(19) United States
(12) Patent Application Publication
(10) Pub. No.: US 2013/0081251 A1
(43) Pub. Date: Apr. 4, 2013

(54) Remotely operated enclosure lock systems

(71) Applicant: Milt Hultberg, Powell Butte, OR (US)

(72) Inventor: Milt Hultberg, Powell Butte, OR (US)

(21) Appl. No.: 13/573,733

(22) Filed: Oct. 3, 2012

Related U.S. Application Data
(60) Provisional application No. 61/542,609, filed on Oct. 3, 2011.

(51) Int. Cl. E05B 47/02; B23P 11/00

(52) U.S. Cl. 29/428; 292/144; 70/280

(57) ABSTRACT

Lock systems for selectively securing and accessing an enclosure include a housing having a movable locking member disposed therein, with the housing being suitable for installation on the enclosure interior, for example proximate a door. A drive device disposed in the housing is operable to move the locking member between locked and unlocked positions, to correspondingly engage and disengage the door. A receiver responsive to signals transmitted by one or more remote control units selectively operates the drive device. Some embodiments include a wireless remote control unit as well as a wired remote control unit, and may couple with an external power supply to power various components of the lock system.

### CROSS REFERENCE TO RELATED APPLICATION

This application claims priority to U.S. Provisional Application, Ser. No. 61/542,609, filed on Oct. 3, 2011, which is hereby incorporated by reference for all purposes.

### TECHNICAL FIELD

This disclosure relates to lock systems, and in particular to lock systems adapted for use on the interior of an enclosure and activated from positions outside the enclosure.

### BACKGROUND

Enclosures that are commonly used to contain and safeguard valuable items may assume all manner of forms, including safes and other compartments; sheds, garages, or other permanent structures or parts thereof; vehicles or portions thereof (such as a trunk); trailers adapted to be towed behind vehicles (such as a horse trailer); and so forth. Such enclosures may serve to isolate items stored inside the enclosure from the elements, from animals, and/or from unauthorized persons, and generally include a door allowing access within.

In general, lock systems may keep an enclosure door in a locked position, preventing unauthorized access to the interior of an enclosure, and may take a variety of forms. Many enclosures are designed to incorporate a lock system: for example, a vehicle trunk typically includes an integrated lock system installed during manufacture. For other enclosures, a range of door lock designs, such as padlocks, locksets, deadbolts, and so forth, may be used.

However, many door lock designs may not be compatible with some enclosure and/or door configurations. Deadbolts, for example, require a cavity to be formed in the door and/or the doorframe for installation, and while suitable for wood or steel doors traditionally used in homes and buildings, deadbolts may be quite cumbersome to install in some enclosures—for example, horse trailer doors, which typically have a different composition and/or configuration.

An alternative for some enclosure configurations is the use of a padlock or other locking mechanism mounted and operated on the exterior of the door. Although perhaps more versatile, the use of an exterior padlock, like other exterior installations, exposes the lock system to tampering or even being disabled. For example, padlocks may be compromised by being picked, smashed, cut open, and so forth.

Additionally, a limitation of many lock systems is a lack of redundant or backup operating means. A primary purpose of security systems is the provision of selective access to an enclosure, which requires that the security system is readily locked and unlocked. Conventional lock systems only provide a single operating means, such as a single padlock combination, a single keyhole for a key, and so forth. The drawback with such configurations is that if the operating means are somehow compromised (e.g., the user forgets the padlock combination, loses the key or locks it inside the enclosure, breaks the key inside the keyhole, and so forth), access to or locking of the enclosure is not possible.

### SUMMARY

Various embodiments of a lock system for selectively locking and unlocking an enclosure are disclosed herein. In some embodiments, the lock system includes a housing having a movable locking member disposed at least partially within, with the housing being suitable for installation on the interior of an enclosure, for example proximate a door thereto. Such embodiments may be actuable via one or more control units located remotely from the housing, for example to allow the enclosure to be locked and unlocked by a user on the outside of the enclosure by means of a control unit.

In particular, some embodiments of the lock system, in addition to a housing and a movable locking member at least partially disposed in the housing, also include a drive device disposed in the housing and being operable to move the locking member between locked and unlocked positions (which may correspond to positions in which the locking member respectively engages, and does not engage, the door), and a receiver operably coupled to the drive device and being responsive to signals transmitted from the one or more remote control units.

In some embodiments, the one or more control units may include redundant units, such as a primary unit and a backup unit. In such embodiments, the redundant control units may take different forms, such as a primary unit in the form of a wireless remote control unit, and a backup unit in the form of a wired remote control unit. As explained below, in some installations, for example when the enclosure with which the lock system is used is part of a vehicle trailer, the wired remote control unit may be installed at a concealed location elsewhere on the vehicle trailer, and/or may be operable only via a key.

In some embodiments, the lock system may be powered by a power source located in the housing, such as in the form of one or more batteries, and/or may be powered by an external power source, such as by coupling the drive device and/or other powered components of the lock system to a power supply. Such a power supply may be selected according to the nature of the enclosure with which the lock system is used, and therefore may include a vehicle power supply, a trailer power supply, a structural power supply, and so forth.

The concepts, features, methods, and component configurations briefly described above are clarified with reference to the accompanying drawings and detailed description below.

### BRIEF DESCRIPTION OF THE DRAWINGS

FIG. 1 is a schematic view showing an illustrative example configuration of a lock system in accordance with the present disclosure.

FIG. 2 is a partially-schematic top view of an example commercial embodiment of a lock system in accordance with the present disclosure, with the housing shown in partial cutaway to show internal components of the lock system. The lock system of FIG. 2 is shown to be mounted to a wall of an enclosure proximate a door. In other examples, the position of the lock system and the catch may be reversed. For example, the lock system may be mounted to the door of an enclosure in a position to align with the catch mounted to the wall of the enclosure.

FIG. 3 is a partially-schematic top view of an example horse trailer in which components of the lock system of FIG. 2 are shown to be installed.

### DETAILED DESCRIPTION

The lock systems according to the present disclosure are described herein with reference to the drawings, in which illustrative, non-exclusive examples of lock systems and installations thereof are illustrated. The lock systems and various components, assemblies, configurations, and other characteristics thereof are not limited to the specific embodiments, and may incorporate any number of the various aspects, configurations, characteristics, properties, etc. of the lock systems illustrated and discussed with reference to the schematic representations and/or embodiments shown in FIGS. 1-3, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to later-discussed embodiments, however, it is within the scope of the present disclosure that the previously discussed features, variants, etc. may be utilized with any of all of the lock systems and configurations described herein.

FIG. 1, for example, schematically shows an illustrative, non-exclusive example of a lock system 10 in accordance with the present disclosure. In general, lock system 10 includes a housing 12 configured to house various components of the lock system, such as a movable locking member 14 that is at least partially disposed in the housing; this is indicated schematically by a portion of the locking member 14 being shown to protrude from the housing 12. As discussed in more detail below, in some embodiments, housing 12 is also configured to be mounted on an interior wall of an enclosure proximate a door, and thus may assume any physical configuration suitable for such installation. In still further embodiments, the housing is configured to be mounted on an interior wall of a door proximate an interior wall of an enclosure, and thus may assume any physical configuration suitable for such installation.

Locking member 14 is movable relative to the housing (and to any structure to which the housing is mounted), such as between a locking position in which a door (not shown) is locked, such as by means of engaging the locking member (or a portion thereof) with the door (or structure mounted thereon), and an unlocked position in which the door is not locked (such as by disengaging the locking member from the door structure). The locking and unlocked positions of the locking member 14 are schematically indicated in dashed and solid lines, respectively.

A drive device 16 is also disposed in the housing and is operably coupled to locking member 14, to move the locking member between the unlocked and locking positions. The movement is shown schematically by arrow A, although the manner of movement typically depends on the nature of the locking member used. In other words, although locking member 14 is shown to move linearly between a locking position that is extended from the housing, and an unlocked position that is substantially restracted into the housing, this is certainly not required to all embodiments. The drive device 16 may include one or more motors, appropriate gear assemblies, hydraulic and/or pneumatic mechanisms, and so forth, as suitable to the particular configuration of the drive device and the application in which the lock system is used. As described in more detail below, in an example commercial embodiment, drive device 16 and locking member 14 are collectively defined by a suitable mechanism such as an actuator (for example, a sliding actuator, a rotary actuator, a linear actuator, and so forth), but this is not required to all embodiments.

A receiver 18 is operably coupled to drive device 16, such as by suitable wiring or other connection means. The dashed portion of housing 12 schematically indicates that receiver 18 may be housed within housing 12. For example, in some embodiments, the receiver may be disposed outside of the housing, such as attached to the housing or even spaced away therefrom. Receiver 18 is configured to be responsive to one or more selectively actuable control devices or units 20 (also collectively referred to herein as a control system 22), each of which are configured to be actuated, such as by a user, to transmit a signal. The receiver is also configured to operate the drive device to move the locking member when a signal is received.

The signal transmission means, schematically indicated by the dashed line connecting the control system 22 to the receiver 18, may be as desired for the particular application. Moreover, more than one signal transmission means may be employed, and/or may differ among control units 20 of the control system 22. For example, some embodiments may include a wired control unit that is hard-wired to the receiver and a wireless control unit that transmits a signal to the receiver via wireless means (for example, radio, IR, WiFi, and so forth). As explained in detail below, some embodiments include a control system 22 having multiple control units 20 (such as a wireless remote control as well as a wired remote control), which may provide a user redundant operating means, such as if a wireless remote control unit is lost or does not function, allowing the wired remote control unit to be used instead.

The lock system 10 includes and/or is coupled to one or more power sources 24, which are configured to provide power to various components of the lock system (e.g., drive device 16, receiver 18, and so forth). For example, as represented schematically in FIG. 1, lock system 10 is coupled to an external power source 24 and may also include an on-board power source 24. The nature of the power source may be a function of the configuration of the lock system components. For example, if the drive device and/or receiver are electrically powered, examples of external power sources may include an electrical power supply such as a vehicle power supply, a building power supply, and so forth, whereas examples of on-board power sources may include one or more batteries.

As with the receiver 18, an on-board power source may be commonly housed in the housing 12 or disposed without. In embodiments including and/or coupled to multiple power sources, the lock system may be configured, such as by means of a switch device, appropriate circuitry, and so forth, to draw power from one power source as a primary power source, and to draw power from a secondary or backup power source in the event that the primary power source fails to provide power.

In operation, the lock system 10 may be used to selectively lock and unlock a door of an enclosure. For example, the lock system 10 is operable by means of a user actuating one of the control units 20 to transmit a signal to the receiver 18. Upon receipt of the signal, the receiver operates the drive device to move the locking member from the locking to the unlocked position (or vice versa), such as to enable the user to remotely lock or unlock the door to the enclosure. As such, the lock system 10 is suitable for installation on the interior of an enclosure, safeguarding the components thereof from both exposure and possible compromise by unauthorized personnel, but may be readily operated from the exterior via one or more control units 20. Moreover, the lock system 10 may provide backup operating means in the event that one of the control units fails to function.

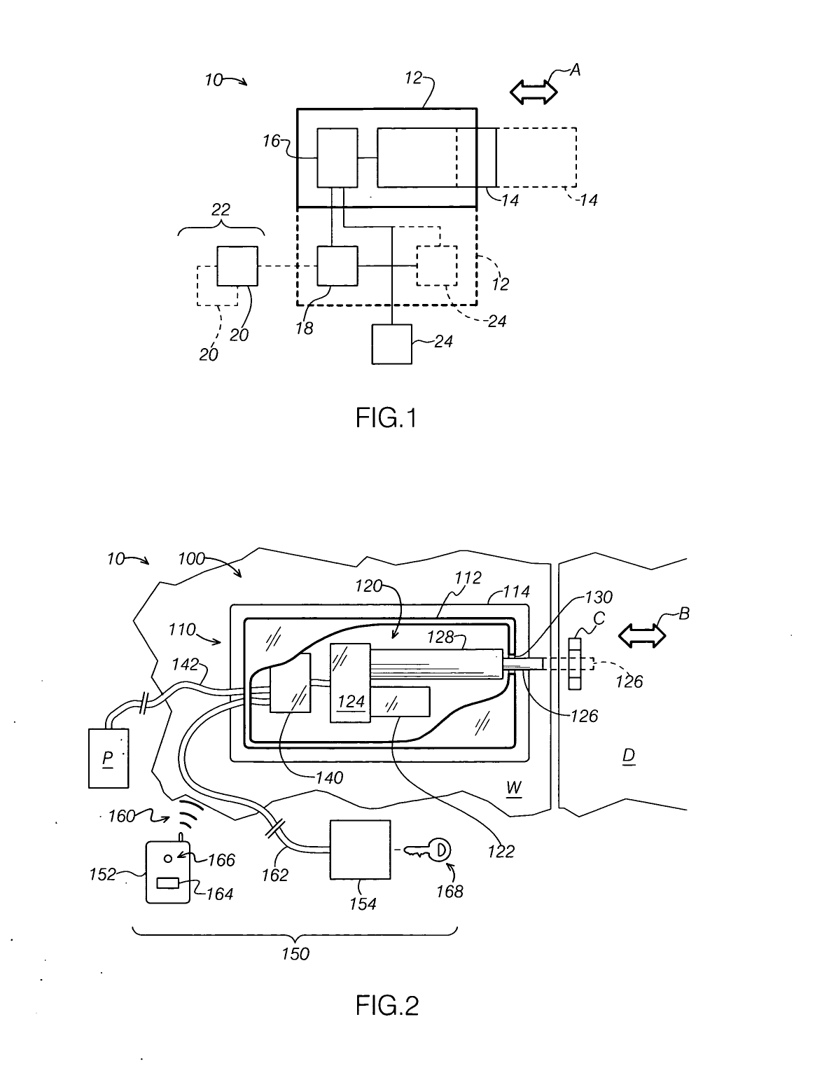

FIG. 2 is a partially-schematic top view of an example commercial embodiment of a lock system 10 in accordance with the present disclosure. By way of example only, the lock system 10 shown in FIG. 2 and generally indicated at 100, and the illustrated components thereof, are described herein and shown in the form and configuration of a commercially provided lock system in use with an enclosure disposed in a trailer designed to be towed behind a vehicle. Specifically, the commercial embodiment is shown and described for installation and use in a tack room of a horse trailer. However, it is intended that the concepts and configurations described below are applicable to applications other than installation and use in horse trailers, including use in other types of vehicle trailers or mobile structures, as well as in vehicles, and/or permanent structures such as storage sheds, houses, and other buildings, and portions thereof such as rooms or closets, and so forth. Such applications are considered to be within the scope of this disclosure.

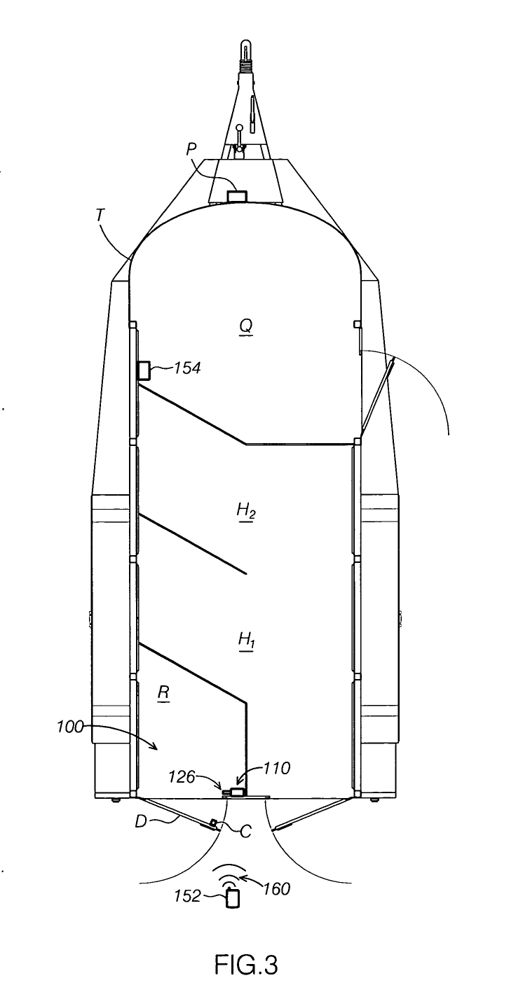

As shown, for example, in FIG. 3, a horse trailer (indicated at T) typically includes several interior rooms or enclosures, depending on its size, such as living or dressing quarters (Q), one or more horse stalls (H₁, H₂), and a tack room (R) that is generally used for storing horse tack (e.g. saddles, harnesses, stirrups, and other equestrian equipment or accessories). The tack room and other enclosures are typically each provided with an exterior door, which is generally desired to be kept locked when the tack room is not in use, considering that the equestrian equipment typically stored therein is often quite costly. Many users of horse trailers find the conventional method of securing a tack room door, e.g. with a padlock on the exterior, to be faulty for the reasons explained above—that is, an exterior padlock is susceptible to being compromised by an intruder, does not offer backup operating means, and so forth. As such, lock system 100 is shown in FIGS. 2 and 3 to be installed on the interior of the tack room, yet is operable from the exterior.

With reference to FIG. 2, lock system 100 can be seen to include a housing 110 that includes a cover 112 attached to a mounting plate 114. The mounting plate is shown to be installed to an interior wall W of a tack room, proximate a door D thereto, by any suitable means (such as screws or other fasteners, adhesives, etc.). In other examples, the position of the mounting plate may be reversed to be installed on an interior wall of the door, proximate a wall of the tack room.

In FIG. 2, cover 112 is illustrated in partial cutaway to show internal components of the lock system 100. In the commercial embodiment, housing 110 is fabricated of aluminum, but any suitable lightweight, rigid material may be used.

Housing 110 houses a movable locking member and drive device in the collective form of an electric linear actuator 120, although any suitable manner of actuator that is compatible in size, operation, and moving mechanics with the particular application may be used. For example, in other embodiments, a sliding actuator or rotary actuator may be used; in still others, a pneumatically- or hydraulic-powered actuator or mechanism may be used, and/or a configuration in which the movable locking member and drive device are provided as separate components.

In the commercial embodiment of the lock system 100 shown in FIGS. 2 and 3, a concentric LACT2P-12V-20 linear actuator, available from Pololu Robotics and Electronics of Las Vegas, Nev., is used. Linear actuator 120 is somewhat schematically shown to include a motor 122, a gear box 124, a movable shaft 126, and a screw/shaft housing 128, and is oriented in the housing 110 so that the shaft 126 extends through an opening 130 formed in one side of the cover 114. In particular, the housing 110 is installed relative to the wall W and door D so that the shaft, when in an extended position (shown in dashed lines), bridges the gap between wall W and door D. Door D is shown to include a catch C installed thereon to receive the end portion of shaft 126 when extended, but any suitable arrangement and/or structure that allows shaft 126 to engage door D may be used. For example, in some horse trailers, an inwardly protruding hollow tube is disposed along the edge of the door; in such configurations, instead of a catch being installed to the interior door surface, a hole may be formed in the side of the tube to receive the shaft 126 when extended.

As such, it is evident that in the configuration shown in FIG. 2, the shaft 126 may be operated to move, as indicated by arrow B, between an extended position (shown in dashed lines) and a retracted position (shown in solid lines). Thus, when moved to the extended position, the shaft engages and locks the door D, and when moved to the retracted position, the shaft disengages and unlocks the door D.

In general, housing 110 is configured to seal the internal components thereof from moisture and debris, such as via a fluid-tight permanent or selectively removable attachment of the cover 112 with the mounting plate 114. A linear actuator such as the aforementioned LACT2P-12V-20 model includes an internal seal disposed within the screw/shaft housing; thus, the opening 130 may be sized to the diameter of the housing or be otherwise configured to prevent debris or moisture from entering, in any suitable manner.

Lock system 100 is (somewhat schematically) shown to include a receiver 140 that is operably coupled to, and configured to control, the actuator 120, and that is shown to be commonly housed in housing 110. Receiver 140 is coupled to a power supply P (such as the trailer power supply and/or the power supply of the vehicle behind which the trailer is towed) by means of wiring 142. As described above, the receiver is configured to be responsive to operational control signals transmitted by a selectively actuable control system 150, which in lock system 100 is shown to include a wireless remote control unit 152 as well as a wired remote control unit 154. Specifically, the receiver is responsive to operational control signals transmitted by either control unit 152, 154 to open or close an electrical circuit between the motor and the power supply, which in turn moves the shaft 126 between positions to lock or unlock the door.

As noted above, a remote control system such as remote control system 150 may include any number of remote control units, which in turn may be configured to communicate in any desired manner with the receiver. Lock system 100 is shown to include two remote units: wireless unit 152, which is configured to communicate with the receiver 140 via wireless signals (generally indicated at 160), and wired unit 154, which is configured to communicate with receiver 140 via wired signals (generally indicated at 162).

The remote units 152, 154 may assume any suitable configuration as known in the art, and thus are shown somewhat schematically in FIG. 2. For example, wireless remote unit 152 is shown to include a button or other input 164, as well as an LED or other output 166, for example to indicate to the user that the unit has transmitted a wireless signal when the button is pressed. Wired remote unit 154 is shown to be operable by means of a key 168 that may be received in a corresponding slot (not shown), and includes an internal system to transmit a signal upon rotation of the key in the slot. However, any manner or configuration of remote units (and a compatible receiver) may be used. In some embodiments, for example those in which the receiver is configured to communicate via WiFi or another manner of internet-related protocol, a wireless remote unit may take the form of a personal computer, such as a smartphone, a tablet computer, a laptop or desktop, and so forth. Moreover, variations of lock system 100 may be provided with multiple wired and/or wireless units.

The remote control system 150 of lock system 100 may provide a user with backup operating means for the lock system. For example, referring to FIG. 3, an example installation of components of lock system 100 is shown to include housing 110 installed in tack room R proximate door D, with shaft 126 positioned to engage catch C when the door is closed. The lock system 100 is coupled, such as by suitable wiring connections (not shown) to the trailer power supply, schematically indicated at P. Wireless remote unit 152 is schematically shown to be positioned outside the tack room, such as if carried by a user desiring to operate the lock system 100. Wired remote unit 154, however, is shown to be installed in the living quarters Q, for example on an interior wall thereof, which may be inside a cabinet or other structure or otherwise concealed from plain view. Wired remote unit 154 thus may function as a backup control unit in the event that wireless remote unit 152 fails to function (e.g., due to a dead battery or otherwise) or is misplaced.

In lock system 100, receiver 140 is configured to receive wireless signal transmissions 160 (from wireless remote control unit 152) as well as wired signal transmissions 162 (from wired remote control unit 154). Any suitable receiver, or set of components that cooperate to provide similar functions and operability, may be used. For example, in some embodiments, the receiver may include IR functionality to receive IR signals from a compatible remote control unit; in others, the receiver may instead or additionally include radio communication functionality, and so forth.

Optionally, the receiver may be configured, such as by programming or suitable circuitry, to provide additional security in certain circumstances. For example, the receiver may be able to distinguish among multiple remote control units of the remote control system, such as between wireless remote control unit 152 and wired remote control unit 154. This may be useful, for example, if the wireless unit 152 is the primary control unit and the wired unit 154 is the backup, as shown in the example installation illustrated in FIG. 3. Further, if the wireless unit 152 is misplaced, to prevent the possibility of further use thereof, such as if the unit 152 is found or stolen by unauthorized persons, the receiver may be configured to ignore signals transmitted by the wireless unit 152 upon receiving a signal from the backup wired unit 154. In such an embodiment, the receiver may be provided with a reset function once the wireless unit 152 is found or replaced.

Trailer power supply P may be any suitable power supply to power components of lock system 100, such as a 12-volt battery (or multiple batteries providing a desired storage capacity) onboard the horse trailer. Optionally, lock system 100 may, in some embodiments, be configured to couple to another power source, such as a vehicle power supply, such as to reduce strain on the horse trailer battery. As indicated above, although lock system 100 is not shown to include an onboard battery, but rather is coupled to external power supply P, variations of the lock system may include an internal battery or batteries (or other power source), as an alternative to, or in addition to, being coupled to external power supply P.

An example method of securing an enclosure having a door, such as tack room R of horse trailer T, is explained with reference to FIGS. 2 and 3. The method may include providing lock system 100, and installing the housing thereof to an interior wall of the tack room R as shown in FIG. 3. Optionally, the installation step may include installing hardware such as a catch member C to the interior of the door in a manner to align the hardware to receive the shaft 126 of the lock system. (Alternatively, the method may include installing the lock system housing on an interior surface of door D of tack room R, and installing hardware such as catch member C to an interior wall of tack room R.) Once installed, the method may include actuating the actuator 120 with control unit 152 or 154 from outside the tack room to move the shaft 126 to the locked position, in which it engages catch member C of the door D.

Although the present invention has been shown and described with reference to the foregoing operational principles and illustrated examples and embodiments, it will be apparent to those skilled in the art that various changes in form and detail may be made without departing from the spirit and scope of the invention. The present invention is intended to embrace all such alternatives, modifications and variances that fall within the scope of the appended claims.

1. A lock system comprising:
a housing;
a movable locking member at least partially disposed in the housing;
a drive device disposed in the housing and operable to move the movable locking member between a locked position and an unlocked position;
a receiver operably coupled to the drive device; and
a selectively actuable control device located remotely from the housing configured to transmit a signal to which the receiver is responsive.

2. The lock system of claim 1,
wherein the housing is configured to be mounted on an interior wall of an enclosure proximate a door; and
wherein in the locked position the locking member retains the door in a closed position.

3. The lock system of claim 1,
wherein the movable locking member includes a shaft slidably disposed at least partially within the housing; and
wherein in the locked position, the shaft extends from the housing, and in the unlocked position, the shaft is substantially retracted into the housing.

4. The lock system of claim 3, wherein when the housing is mounted on an interior wall of an enclosure proximate a door, the shaft in the locked position engages the door and in the unlocked position does not engage the door.

5. The lock system of claim 1, wherein the drive device includes a motor.

6. The lock system of claim 5, wherein the motor is adapted to be coupled with at least one power source operable to power the motor.

7. The lock system of claim 6, further including a power source disposed within the housing;
wherein the power source disposed within the housing includes one or more batteries.

8. The lock system of claim 7:
wherein the power source disposed within the housing defines a secondary power source;
wherein the motor is configured to be coupled with a primary power source external to the lock system; and
wherein the secondary power source is configured to provide power to the motor in the event that the primary power source fails to do so.

9. The lock system of claim 6:
wherein the housing is configured to mount to a trailer configured to be towed behind a vehicle; and
wherein the motor is configured to be coupled to a power source in the form of a trailer power supply configured to provide power to components of the trailer.

10. The lock system of claim 5, wherein the movable locking member and the drive device are collectively in the form of a linear actuator.

11. The lock system of claim 1, wherein the control device includes a wireless remote control device.

12. The lock system of claim 1, wherein the control device includes a wired remote control device.

13. The lock system of claim 12, further including a key configured to actuate the wired remote control device.

14. The lock system of claim 1, wherein the receiver is disposed within the housing.

15. The lock system of claim 1, wherein the housing is sealed to prevent moisture and debris from entering the housing.

16. A method of securing an enclosure having a door, the method comprising:
providing the lock system of claim 1;
installing the housing to the interior of the enclosure proximate the door in an orientation in which in the locked position, the locking member prevents the door from opening, and in which in the unlocked position, the door may be opened; and
actuating the control device from outside the enclosure to operate the drive device to move the movable locking member to the locked position.

17. A lock system comprising:
a housing configured for installation to an interior wall of an enclosure proximate a door;
a movable locking shaft at least partially housed in the housing and configured to slide relative thereto between an extended, locked position in which the locking shaft engages the door and a retracted, unlocked position in which the locking shaft does not engage the door;
a motorized drive device disposed in the housing and operable to slide the movable locking shaft between the locked and unlocked positions;
a receiver disposed in the housing and operably coupled to the drive device;
a power source configured to provide power to the receiver and the drive device; and
a selectively actuable control system located remotely from the housing that includes at least two control units each configured to transmit a signal to which the receiver is responsive;
wherein the at least two control units include:
a wireless remote control, and
a backup wired remote control actuable by means of a key.

18. A method of securing an enclosure having a door, the method comprising:
providing a remotely controllable locking unit that includes a locking shaft selectively operable to slide relative to a housing between an extended, locked position and a retracted, unlocked positions;
installing the housing to the interior of the enclosure proximate the door such that in the extended position, the locking shaft engages and retains the door in a closed position, and that in the retracted position, the locking shaft does not engage the door; and
actuating the locking unit with a remote control device to which the locking unit is responsive from outside the enclosure to operate the locking shaft to slide to the locked position.

19. The method of claim 18,
wherein the installing includes installing a catch member to the interior of the door in an orientation aligned to receive the locking shaft; and
wherein the actuating includes the catch member receiving the locking shaft.

20. The method of claim 18,
wherein the remote control device includes a wireless remote control; and
wherein the actuating includes wirelessly transmitting a signal via the wireless remote control.
